(19) United States
(12) Patent Application Publication
(10) Pub. No.: US 2014/0202821 A1
(43) Pub. Date: Jul. 24, 2014

(54) MODIFIED SPRAG ASSEMBLIES FOR ONE-AND TWO-WAY CLUTCH APPLICATIONS

(71) Applicant: Joshua A. Schotten, Denver, CO (US)

(72) Inventor: Joshua A. Schotten, Denver, CO (US)

(21) Appl. No.: 14/163,917

(22) Filed: Jan. 24, 2014

Related U.S. Application Data
(60) Provisional application No. 61/756,222, filed on Jan. 24, 2013.

(51) Int. Cl. F16D 41/069

(52) U.S. Cl. CPC F16D 41/069
USPC 192/45.1

(57) ABSTRACT

A modified sprag clutch, which can freewheel in both directions until its locking function is employed at which time it will lock in one direction and freewheel in the other, or lock in both directions depending on the placement of the sprag elements, is described. Among other applications, the present modified sprag clutch permits conventional clutch packs and sprag clutches currently employed in automotive transmissions to be retrofitted to eliminate the high-wear friction discs, and to replace conventional one-way sprag clutches. Transmissions may also be designed with the present modified sprag clutches as original equipment.

### CROSS-REFERENCE TO RELATED APPLICATIONS

The present application claims the benefit of U.S. Provisional Patent Application No. 61/756,222 for “Modified Sprag Assemblies For One- And Two-Way Clutch Applications” which was filed on Jan. 24, 2013, the entire contents of which is hereby specifically incorporated by reference herein for all that it discloses and teaches.

### FIELD OF THE INVENTION

The present invention relates generally to clutches and, more particularly, to replacement of clutch packs for transmissions and other uses with modified sprag clutches.

### BACKGROUND OF THE INVENTION

Clutch packs and bands are used to control planetary gear sets in a transmission; that is, a friction clutch connects a rotating member to one that is stationary relative to the rotating member. Typically one-half of the disks inside a clutch drum are steel and have splines that fit into grooves on the inside of the drum, while the other half of the disks, alternating with the steel disks, have a friction material bonded to at least a portion of the disk surface on one or both sides thereof, and have splines on the inside edge thereof that fit grooves on the outer surface of an adjoining hub. Modern clutches typically use a compound organic resin with copper wire facing, a ceramic material, woven fibers materials, or Kevlar, as examples. An oil activated piston inside the drum forces the clutch elements together such that the drum and the hub become locked together and turn as a single unit. The most common problem with clutches is that the friction material on the disks wears out. Once a significant amount of the material is gone, usually in about 100,000-150,000 driving miles, the clutch will begin to slip, and ultimately will no longer transmit power between the hub and the drum.

One-way clutches, also known as sprag clutches, permit a component to turn in one direction, but not in the other; that is, a one-way freewheel clutch. This type of clutch resembles a roller bearing, but in place of cylindrical rollers, non-revolving asymmetric shaped sprag elements are used. When the inner and outer races are rotated in one direction, the elements slip or free-wheel; however, when torque between the races is applied in the opposite direction, the sprag elements tilt slightly, producing a wedging action and binding because of friction. The sprag elements may be spring-loaded so that they may lock with little backlash. Sprag or overrunning clutches are used in some automatic transmissions for allowing the transmission to smoothly change gears under load. Sprag clutches are also used in transmissions which require the automatic synchronized engagement of one clutch with the disengagement of another.

Conventional sprag elements are designed such that a rotation about a longitudinal axis generally resulting from the action of spring elements in the cage in which the elements are disposed, simultaneously brings opposing longitudinal contact surfaces into contact with inner and outer races of a sprag clutch. When torque is applied to the sprag clutch, the sprag elements pivot until equilibrium for the forces between the torque and the wedging tension between the sprag elements and mating races is achieved. The opposing contact surfaces have a complex geometrical shape which is maintained along the longitudinal dimension, and which generates a chosen pitch angle when the elements are in contact with mating cylindrical inner and outer races. That is, the sprag elements rotate such that the long radial dimension of the contact surfaces, defined by a longitudinal axis, which is greater than the distance between the inner and outer races, causes the sprag elements to lock between the races and transfer torque from one to the other. The sprag clutch releases when the sprag elements pivot in the opposite direction such that shorter radial dimensions of the contact surfaces, again defined by the longitudinal axis, which are smaller than the distance between the inner and outer races, face the races.

### SUMMARY OF THE INVENTION

Embodiments of the present invention overcome the disadvantages and limitations of the prior art by providing a sprag clutch having modified sprag elements which freewheels in both directions until a force is applied to the modified sprag elements causing them to rotate into position for preventing relative angular rotation of inner and outer races in one direction.

Another object of embodiments of the present invention is to provide a sprag clutch having modified sprag elements which freewheels in both directions until a force is applied to the modified sprag elements causing them to rotate into position for preventing relative angular rotation of inner and outer races in both directions.

Yet another object of embodiments of the present invention is to provide a modified sprag clutch for replacing friction clutch packs.

Still another object of embodiments of the invention is to provide a modified sprag clutch for replacing friction clutch packs in automotive transmissions.

Another object of embodiments of the present invention is to provide a modified sprag clutch effective for retrofitting automotive transmissions to replace friction clutch packs and conventional sprag clutches.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

To achieve the foregoing and other objects, and in accordance with the purposes of the present invention, as embodied and broadly described herein, an embodiment of the modified sprag clutch hereof includes the replacement of the sprag elements of a conventional sprag clutch with modified sprag elements having the same opposing longitudinal contact faces with a long diagonal dimension and a short diagonal dimension between high regions and low regions of the opposing faces, respectively, effective for generating the lock/freewheel function of conventional sprag clutches by simple rotation about a longitudinal axis formed by the intersection of these diagonals, but having portions removed from opposite longitudinal ends of the contact surfaces extending inwardly to at least the midpoint of the sprag element. Removal of these portions permits rotation of the modified sprag elements around an axis perpendicular to the longitudinal axis of rotation in addition to rotation about the longitudinal axis, which prevents engagement of the sprag element for either direction of relative motion of the inner and outer races of the sprag clutch containing the modified elements, unless these elements are moved into contact with the races by a combination of rotations about the longitudinal axis of rotation and the axis perpendicular thereto. This permits the modified sprag elements to immediately disengage from the inner and outer races of the sprag clutch once the sprag element rotation activation is removed.

Benefits and advantages of embodiments of the present invention include, but are not limited to, replacing existing clutch packs with modified sprag clutches which do not require friction material having limited wear lifetime. Existing one-way sprag clutches may also be replaced with the present modified sprag clutch which may freewheel in both directions until the modified sprag elements are caused to lock, at which time the modified sprag clutch will lock in one direction and freewheel in the other direction in one embodiment of the invention, or lock in both directions, in another embodiment of the invention, depending on the orientation of the sprag elements in the sprag clutch.

### BRIEF DESCRIPTION OF THE DRAWINGS

The accompanying drawings, which are incorporated in and form a part of the specification, illustrate embodiments of the present invention and, together with the description, serve to explain the principles of the invention. In the drawings:

FIG. 1A is a schematic representation of a perspective side view of a conventional sprag element, FIG. 1B is a schematic representation of a side view of the conventional sprag element shown in FIG. 1A, while FIG. 1C is a schematic representation of another side view of the conventional sprag element shown in FIG. 1A.

FIG. 2A is a schematic representation of a top view of a conventional sprag clutch employing a plurality of conventional sprag elements of the type shown in FIGS. 1A-1C hereof, while FIG. 2B is a schematic representation of a side cross sectional view of the sprag clutch shown in FIG. 2A hereof.

FIG. 3A is a schematic representation of a perspective side view of an embodiment of a sprag element modified in accordance with the teachings of the present invention, FIG. 3B is a schematic representation of a side view of the modified sprag element shown in FIG. 3A, and FIG. 3C is a schematic representation of another side view of the modified sprag element shown in FIG. 3A.

FIG. 4A is a schematic representation of a top view of a sprag clutch employing a plurality of modified sprag elements of the type shown in FIGS. 3A-3C hereof, while FIG. 4B is a schematic representation of a side cross sectional view of the sprag clutch shown in FIG. 4A hereof.

FIG. 5 is a schematic representation of an exploded perspective view of a sprag clutch employing a plurality of modified sprag elements as illustrated in FIGS. 4A and 4B hereof.

FIG. 6A is a schematic representation of a side perspective view of an embodiment of the sprag cage assembly of a sprag clutch employing a plurality of modified sprag elements effective for locking corresponding inner and outer race members in both directions of relative rotation, FIG. 6B is a schematic representation of a top view of the sprag cage assembly illustrated in FIG. 6A hereof, and FIG. 6C is a schematic representation of a side view of the sprag cage assembly illustrated in FIG. 6A hereof.

FIG. 7 is a schematic representation of a side perspective view of a cross section of an input drum assembly modified from that of a vehicle transmission, illustrating a piston adapted to contact the inner cage of the modified sprag cage assembly shown in FIGS. 5 and 6A-6C hereof for locking or releasing an embodiment of the modified sprag clutch, hereof.

FIG. 8 is a schematic representation of a side perspective view of a cross section of a prior art input drum assembly such as that found in a vehicle transmission, illustrating a piston adapted for contacting a conventional friction disc clutch pack to engage a prior art sprag clutch as shown in FIGS. 2A and 2B, hereof.

FIG. 9A is a schematic representation of a side perspective view of a cross section of an input drum assembly similar to that shown in FIG. 7, hereof, wherein the piston is adapted for contacting a ring, shown in its uncompressed condition, having radially inwardly facing fingers, one for each sprag element, slanted away from the piston and having lengths and widths chosen such that the fingers may be received by the cutouts in outer sprag cage, but do not rotate the sprag elements, while FIG. 9B illustrates a schematic representation of the side perspective view of the input drum assembly shown in FIG. 9A, hereof, illustrating the piston forcing the ring against one surface of the outer race of the sprag clutch such that the fingers are flattened against the surface, and are effective for rotating every sprag element into locking contact with the inner and outer races of the sprag clutch.

FIG. 10A is a schematic representation of a side perspective view of a cross section of an input drum assembly similar to that described in FIG. 7, hereof, wherein the piston is adapted for sliding between the inner surface of the outer race of the sprag clutch and the outer cage of the sprag cage assembly, without rotating the sprag elements, while FIG. 10B is a schematic representation of a side perspective view of the input drum assembly shown in FIG. 10A, hereof, illustrating movement of the piston into position for rotating every sprag element into locking contact with the inner and outer races of the sprag clutch.

### DETAILED DESCRIPTION OF THE INVENTION

Briefly, embodiments of the present invention include a modified sprag clutch which may freewheel in both directions until its locking function is employed at which time it will lock in one direction and freewheel in the other, or lock in both directions, depending on the placement of the sprag elements. Among other applications, the present modified sprag clutch permits conventional clutch packs and sprag clutches currently employed in automotive transmissions to be retrofitted to eliminate the high-wear friction discs of conventional clutches, and to replace conventional one-way sprag clutches. Modifications to the transmission for such retrofits are minor. Transmissions may also be designed with the present modified sprag clutches as original equipment.

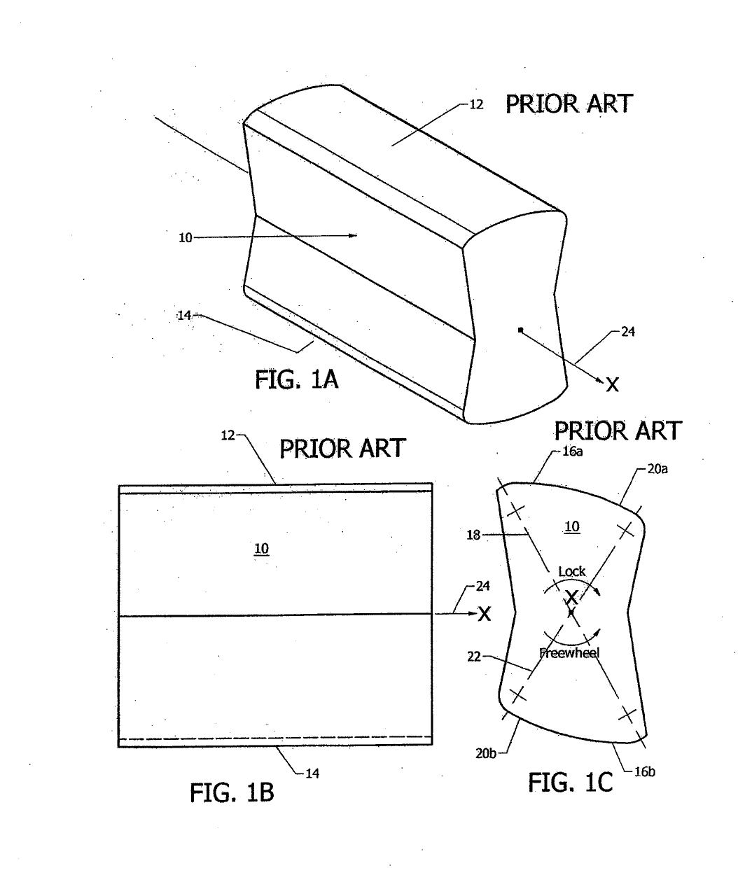

Reference will now be made in detail to the present embodiments of the invention, examples of which are illustrated in the accompanying drawings. In the FIGURES, similar structure will be identified using identical reference characters. It will be understood that the FIGURES are presented for the purpose of describing particular embodiments of the invention and are not intended to limit the invention thereto. Turning now to FIG. 1A, shown is a schematic representation of a perspective side view of conventional sprag element, 10. As will be explained in more detail hereinbelow, a plurality of sprag elements 10 having opposing top and bottom surfaces, 12, and 14, respectively, with complex geometric shapes, are utilized in a sprag clutch. FIG. 1B is a schematic representation of a side view of element 10, while FIG. 1C shows a front view thereof. Surfaces 12 and 14 have high regions, 16a, and, 16b, respectively, having long diagonal, 18, therebetween, and, low regions, 20a, and, 20b, respectively, having short diagonal, 22, therebetween, which permit a conventional sprag clutch to either a lock or freewheel depending on the direction of rotation of sprag elements 10. That is, when element 10 is rotated around longitudinal x-axis, 24, such that long diagonal 18 touches inner and outer races comprising the sprag clutch (not shown in FIG. 1), the sprag clutch will lock in the direction which forces the sprag element to continue rotating in that direction, while when element 10 is rotated such that short diagonal 22 is moved closer to the inner and outer races, the sprag clutch will freewheel.

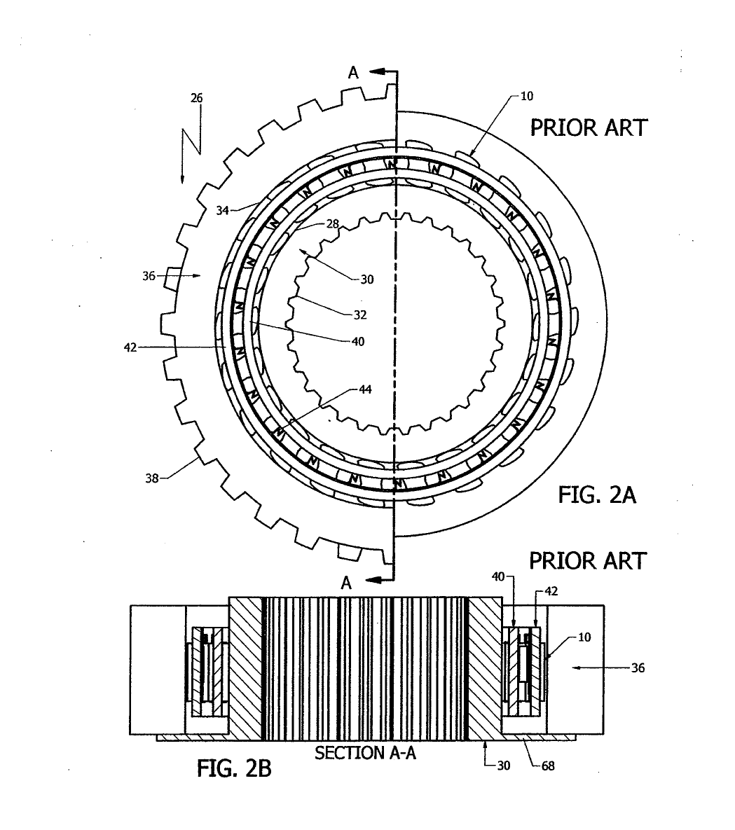

FIG. 2A is a schematic representation of a top view of conventional sprag clutch, 26, employing a plurality of sprag elements 10. Sprag elements 10 are circumferentially disposed between outer cylindrical surface, 28, of inner race, 30, which may have inner splines, 32, and cylindrical inner surface, 34, of outer race, 36, which may have outer splines, 38, such that relative rotational movement of races 30 and 34 causes sprag elements 10 to lock clutch 26, or to permit clutch 26 to freewheel, depending on the direction of relative motion of the races. Conventional sprag clutches only provide locking and freewheel options. Sprag clutch 26 further includes inner cage, 40, outer cage, 42, and spring, 44, for rotating sprag elements 10 into a position where they are effective for locking against outer surface 28 and inner surface 34 of races 30 and 36, respectively, depending on which direction races 30 and 36 are rotated relative to each other. The conventional design permits inner cage 40 and outer cage 42 to move axially a short distance relative to one another, with sprag elements 10 mounted in cages 40 and 42. FIG. 2B is a schematic representation of a side cross sectional view of sprag clutch 26 shown in FIG. 2A.

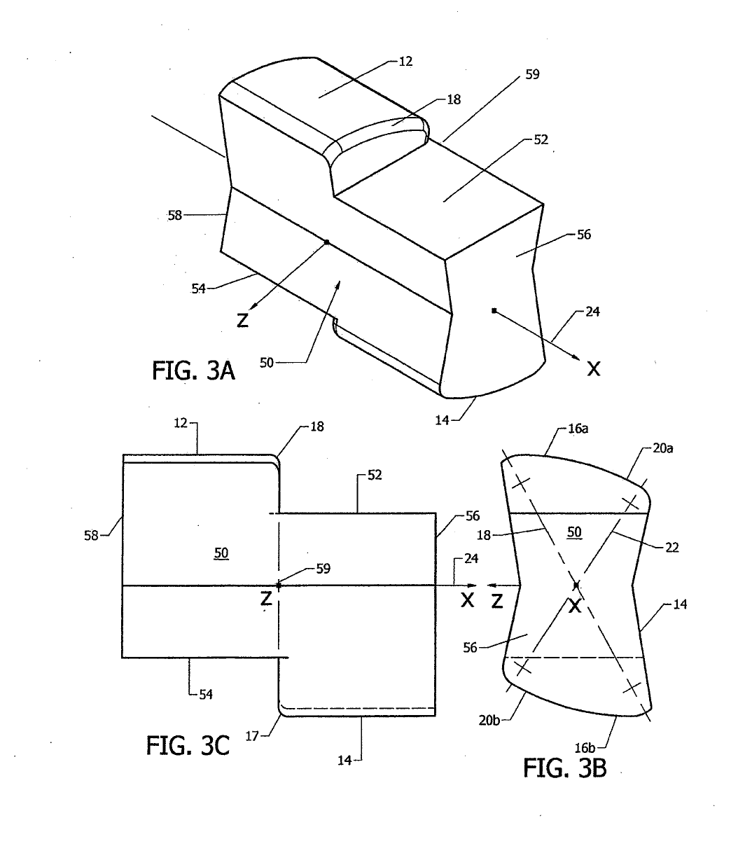

In accordance with the teachings of the present invention, by making modifications to sprag elements 10 described hereinbelow, a sprag clutch similar to the conventional clutch, but with modified sprag elements 50 replacing the conventional elements, can be made to freewheel in both directions until the modified sprag elements 50 are caused to rotate, at which time the sprag clutch will lock in one direction and freewheel in the other direction in one embodiment or, as will be described in more detail hereinbelow, lock in both directions in another embodiment of the invention. Turning to FIG. 3A hereof, a schematic representation of a perspective side view of the modified sprag element 10 is illustrated. Modified sprag element 50 has the same high regions 16a and 16b (long diagonal), and low regions 20a and 20b (short diagonal) on surfaces 12 and 14, respectively, effective for generating the lock/freewheel function of conventional sprag element 10. In modified sprag element 50, however, portions, 52, and, 54, have been removed from opposite ends of surfaces 12 and 14, respectively, and extending inwardly from faces, 56, and, 58, respectively to at least midpoint, 60, of sprag element 50. See also FIG. 3B, which shows a schematic representation of a side view of modified sprag element 50, and FIG. 3C which shows a schematic representation of another side view of modified sprag element 50. As will be described in more detail hereinbelow, removal of portions 52 and 54 permits rotation of sprag element 50 around the z-axis, perpendicular to longitudinal axis 24, which prevents engagement of sprag elements 50 for either direction of relative motion of the inner and outer races of the sprag clutch, unless sprag elements 50 are rotated into contact with the races by a combination of rotations about the z-axis and the x-axis, and permits sprag elements 50 to immediately disengage from the inner and outer races of the sprag clutch once the rotation activation is removed.

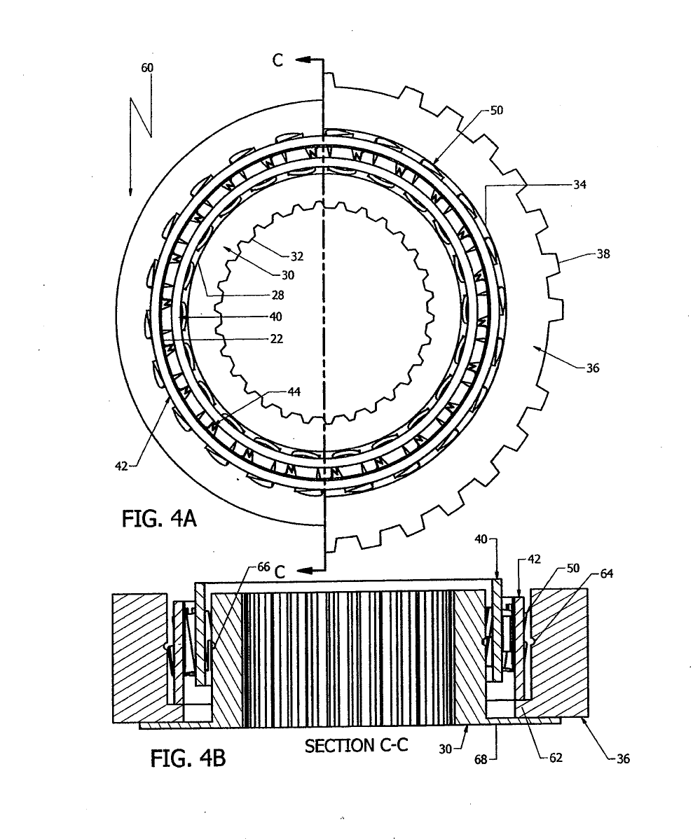

FIG. 4A is a schematic representation of a top view of modified sprag clutch, 60, employing a plurality of modified sprag elements 50. Sprag elements 50 are circumferentially disposed between outer cylindrical surface, 28, of inner race, 30, which may have inner splines, 32, and cylindrical inner surface, 34, of outer race, 36, which may have outer splines, 38. In this embodiment, all sprag elements are identically arranged. As stated hereinabove, relative rotational movement of races 30 and 34 will not cause sprag elements 50 to lock clutch 60 in either direction unless sprag elements 50 are rotated about the z-axis and the x-axis into contact with the races. Rather, unlike conventional sprag clutches, which only provide locking and freewheel options, modified sprag clutch 60 may freewheel in both directions until its locking function is employed. Modified sprag clutch 60 further includes inner cage, 40, outer cage, 42, and spring, 44. The conventional sprag cage design permits inner cage 40 and outer cage 42 to move axially a short distance relative to one another with sprag elements 10 mounted in cages 40 and 42. This same motion will be available with modified sprag elements 50 mounted in the cages.

FIG. 4B is a schematic representation of a side cross sectional view of sprag clutch 60 shown in FIG. 4A, further illustrating lip, 62, in outer race 36 for supporting outer cage 42, outer race lubrication/anti-wear groove, 64, inner race lubrication/anti-wear groove, 66, through which lubrication may be added to reduce wear on the contacting surfaces, and lip, 68, in inner race 30 for in part preventing relative motion of inner race 30 and outer race 36. Lip 68 is not present in prior art sprag clutches, and may be omitted from embodiments of the modified clutch hereof.

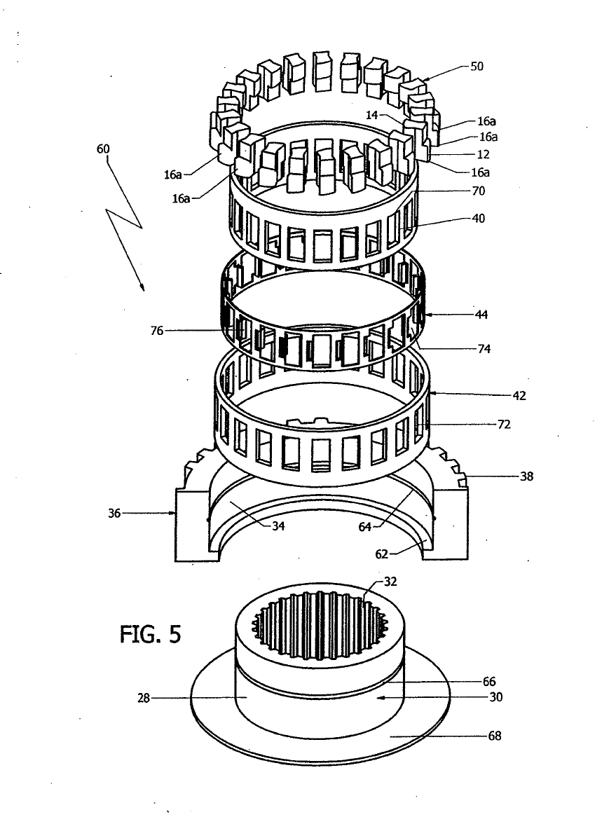

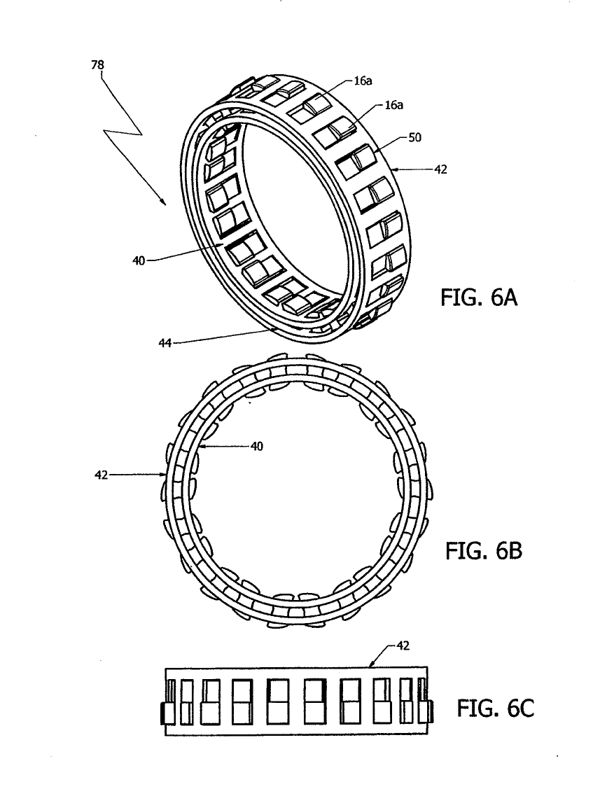

FIG. 5 is a schematic representation of an exploded perspective view of modified sprag clutch, 60, employing a plurality of modified sprag elements 50 illustrated in FIGS. 4A and 4B hereof. As stated hereinabove, sprag elements 50 are circumferentially disposed between outer cylindrical surface, 28, of inner race, 30, which may have inner splines, 32, and cylindrical inner surface, 34, of outer race, 36, which may have outer splines, 38, with all sprag elements being identically arranged. That is, as an example, each sprag element 50 has high region 16a on the same side of surface 12 facing inner surface 34 of outer race 36 around sprag clutch 60. Also as stated hereinabove, relative rotational movement of races 30 and 34 will not cause sprag elements 50 to lock clutch 60 in either direction unless sprag elements 50 are rotated into contact with the races. Rather, unlike conventional sprag clutches, which only provide locking and freewheel options, modified sprag clutch 60 may freewheel in both directions until its locking function is employed, at which time it will lock in one direction and freewheel in the other or, in another embodiment of the invention which will be described in FIGS. 6A and 6B hereof, will lock in both directions. Modified sprag clutch 60 further includes inner cage, 40, outer cage, 42, and spring, 44. Surfaces 12 and 14 of sprag elements 50 extend through corresponding cutouts, 70, 72, and, 74, of inner cage 40, outer cage 42, and spring 44, respectively, and are rotatably held in place by spring elements, 76.

FIG. 6A is a schematic representation of a side perspective view of an embodiment of sprag cage assembly, 78, of modified sprag clutch 60 employing a plurality of modified sprag elements 50 effective for locking in both directions of relative rotation of corresponding race members 30 and 36 shown in FIG. 5 hereof. Unlike sprag elements 50 illustrated in FIG. 5 hereof, sprag elements 50 are circumferentially disposed such that each sprag element 50 has high region 16a on the opposite side of surface 12 facing inner surface 34 of outer race 36 around sprag clutch 60, as its neighboring spag element. Similar to clutch 60 of FIG. 5 hereof, relative rotational movement of races 30 and 34 will not cause sprag elements 50 of sprag cage assembly 78 of FIG. 6B to lock clutch 60 employing sprag cage assembly 78 unless sprag elements 50 are rotated into contact with the races. However, unlike conventional sprag clutches, which provide locking and freewheel options, and unlike modified sprag clutch 60 of FIG. 5 hereof, which may freewheel in both directions until its locking function is employed at which time it will lock in one direction and freewheel in the other, inner and outer races employing sprag cage assembly 78 in clutch 60 will freewheel in both directions until sprag elements 50 are rotated into their locking positions at which time clutch 60 will lock in both directions. Since one half of the sprag elements will be utilized in locking clutch 60 in each direction, the holding efficiency of clutch 60 may be reduced.

FIG. 6B is a schematic representation of a top view of sprag cage assembly 78 illustrated in FIG. 6A hereof, while FIG. 6C is a schematic representation of a side view of sprag cage assembly 78 illustrated in FIG. 6A hereof.

As mentioned hereinabove, existing sprag assemblies permit inner cage 40 and outer cage 42 to axially float relative to one another with sprag elements 10 mounted in place in the cage assembly. This floating capability is used to engage or disengage sprag clutch 60 of the present sprag assembly with sprag elements 50 mounted in the cage assembly. Sprag assemblies having only a single outer cage 42 and a spring element 44 may be employed and actuated in accordance with embodiments of the present invention illustrated in EXAMPLES 2 and 3 hereof.

It should be mentioned that greater holding efficiency of clutch 60 may be obtained by providing cages holding two or more rows of sprag elements, and correspondingly expanding the inner and outer races in the longitudinal dimension. Additional holding efficiency may also be obtained increasing the length of sprag elements 50 over that for conventional sprag elements 10, with corresponding increases in the longitudinal dimensions of the inner and outer races of clutch 60. In either of these two situations, new sprag clutches will be required, as opposed to simple retrofitting of existing sprag clutches with modified sprag elements in accordance with embodiments of the teachings of the present invention. As stated hereinabove and illustrated in FIGS. 3A-3C hereof, in modified sprag elements 50, portions, 52, and, 54, have been removed from opposite ends of surfaces 12 and 14, respectively, and extending longitudinally inwardly from faces, 56, and, 58, respectively to at least midpoint, 59, of sprag element 50. Additional material may be removed, but again, the holding efficiency of the sprag elements will be adversely affected.

Having generally described the present invention, the following EXAMPLES provides additional details of the use of an embodiment of locking clutch 60 hereof in an automobile transmission.

### Example 1

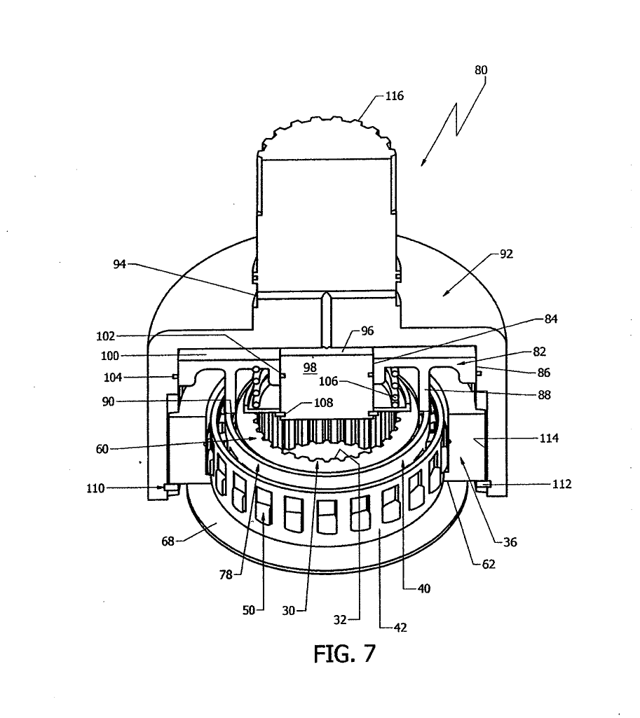

FIG. 7 is a schematic representation of a side perspective view of a cross section of input drum assembly, 80, modified from that of a vehicle transmission, as will be described in more detail hereinbelow, illustrating piston, 82, having inner diameter, 84, and outer diameter, 86. Cylindrical extension, 88, on piston 82 is adapted for contacting inner cage 40 of sprag assembly 78 at contact region, 90. Piston 82 may be hydraulically or electromagnetically activated through drum housing, 92, that guides its axial movement to sprag clutch 60. In FIG. 7, piston 82 is moved by hydraulic fluid entering port, 94, flowing into chamber, 96, in cylindrical hub, 98, of housing 92, and into region, 100, above piston 82, causing axial motion of piston 82 toward sprag assembly 78. Inner piston seal, 102, and outer piston seal, 104, seal piston 82 to hub 98 and to drum 92, respectively.

Hub 98 holds return spring, 106, stationary with respect to drum 92 using snap ring, 98, in snap ring groove, 108. The opposite end of spring 106 contacts piston 82 and counters the axial force provided by piston 82. When piston 82 is activated by the hydraulic fluid it forces inner cage 40 downward, relative to outer cage 42, which in turn rotates every sprag element 50 into its applied position. The region of contact 90 between cylindrical extension 88 and inner cage 40 is chosen to be inside outer cage 42 to avoid damage to outer cage 42. A natural taper might be added to cylindrical extension 88 to reduce wear.

When inner cage 40 is fully depressed by the action of piston 82 and sprag elements 50 are fully engaged with inner race 30 and outer race 36, sprag clutch 60 is locked in one direction and may freewheel the other, or may be locked in both directions as described hereinabove. When the pressure on piston 82 is released, piston return spring 106 moves piston 82 away from inner cage 40, thereby permitting sprag elements 50 to disengage from races 30 and 36 and rotate away from races 30 and 36, allowing these races to freewheel in both directions. An axial movement of between about 0.010 in. and about 0.020 in. of inner cage 40 of sprag assembly 78 is sufficient to achieve this effect. Outer race 36 is held in drum 92 by retaining snap ring, 110, in snap ring groove, 112, but might be formed as a portion of inner surface, 114, of drum 92 to save weight and space. Using a conventional sprag clutch with sprag elements modified in accordance with the teachings of the present invention with 90-95 psi pressure applied to piston, 82, races 30 and 36 were found to lock to 150 ft·lbs of applied torque.

Input drum assembly 80 has input splined portion, 116, for mating to a source of rotation. Inner splines 32 of inner race 30 mate to splines disposed on a shaft to be rotationally driven by drum assembly 80 through clutch 60.

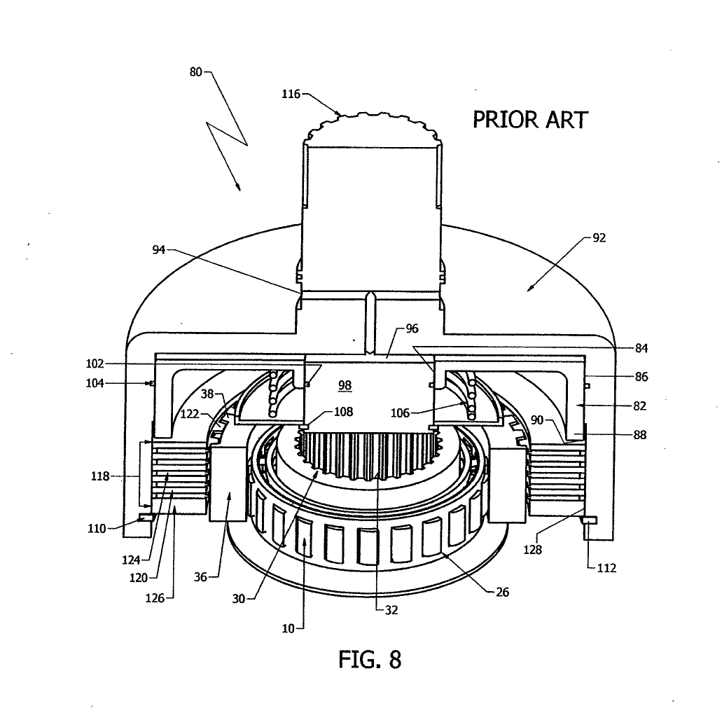

FIG. 8 is a schematic representation of a side perspective view of a cross section of prior art input drum assembly, 80, such as that found in a vehicle transmission, illustrating piston, 82, having inner diameter, 84, and outer diameter, 86. Cylindrical extension, 88, on piston 82 is adapted for contacting friction disc clutch pack, 118, at contact region, 90. Clutch pack 118 may include internally splined steel discs, 120, with splines, 122, adapted to match external splines 38 of outer race 36 and friction discs 124, therebetween, and acts against pressure plate, 126, held by retaining snap ring 110 in snap ring groove 112 in drum housing 92. Pressure plate 126 is attached to inner wall, 128, of drum 92. As stated hereinabove, piston 82 may be hydraulically or electromagnetically activated through drum housing, 92, that guides its axial movement to compress clutch pack 118. To move piston 82, hydraulic fluid enters port, 94, flows into chamber, 96, in cylindrical hub, 98, of housing 92, and into region, 100, above piston 82, causing piston 82 to move axially toward clutch pack 118. Inner piston seal, 102, and outer piston seal, 104, seal piston 82 to hub 98 and to drum 92, respectively.

Hub 98 holds return spring, 106, stationary with respect to drum 92 using snap ring, 98, in snap ring groove, 108. The opposite end of spring 106 contacts piston 82 and counters the axial force provided by piston 82. When piston 82 is activated by the hydraulic fluid it forces clutch pack 118 to compress against pressure plate 126, which is attached to hub 92, thereby permitting forces applied to hub 92 from splined portion 116 to be transmitted to inner race 30 of conventional sprag clutch 26.

As may be observed from FIGS. 7 and 8 hereof, with a simple modification to piston 82 illustrated in FIG. 7, clutch pack 118 and prior art sprag clutch 26 of an automotive transmission may be retrofitted with an embodiment of modified sprag clutch 60, to achieve the benefits of the present invention, which include the elimination of the friction discs of conventional clutches, and the replacement of conventional one-way sprag clutches with modified sprag clutches, which may freewheel in both directions until their locking function is employed at which time they will lock in one direction and freewheel in the other, or lock in both directions. Of course, transmissions may be designed with modified sprag clutches as original equipment.

The following two EXAMPLES illustrate embodiments of the present invention for generating the combination of rotations about the z-axis and the x-axis of sprag elements 50 which forces sprag elements 50 into contact with inner race 30 and outer race 36 of sprag clutch 60, and which permits sprag elements 50 to immediately disengage from these races once the rotation activation is removed. These embodiments illustrate apparatus for directly rotating sprag elements 50. As stated hereinabove, free rotation of sprag element 50 around the z-axis prevents engagement of sprag elements 50 for either direction of relative motion of the inner and outer races of the sprag clutch, unless sprag elements 50 are forced to rotate into contact with the races.

### Example 2

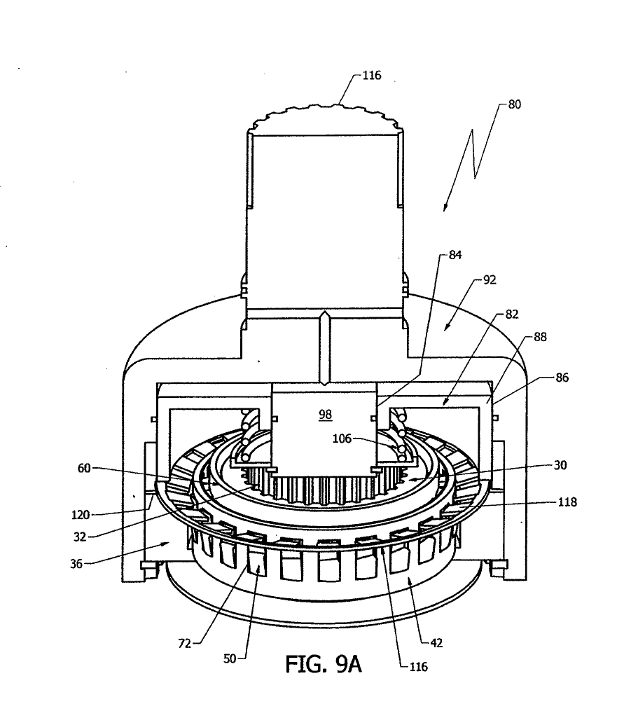

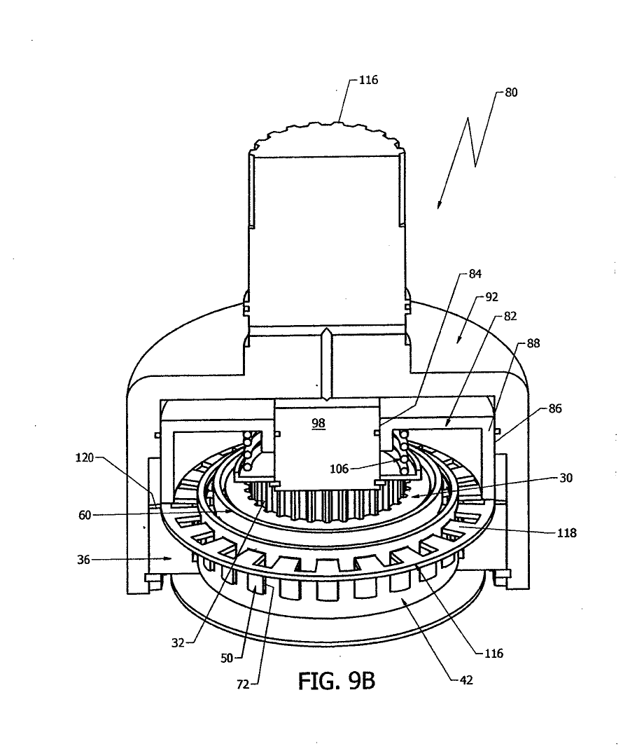

FIG. 9A is a schematic representation of a side perspective view of a cross section of input drum assembly, 80, similar to that described in FIG. 7, hereof, wherein cylindrical extension, 88, on piston 82 is adapted for contacting ring, 116, shown in its uncompressed condition, having radially inwardly facing fingers, 118, one for each sprag element 50, slanted away from piston 82, and having lengths and widths chosen such that fingers 118 fit into cutouts 72 in outer cage 42 of sprag cage assembly 78 (See FIGS. 6A-6C, hereof.), but do not rotate sprag elements 50. Ring 116 is rotationally fixed with respect to outer cage 42, and may be fabricated from spring steel.

When piston 82 is activated, ring 116 is forced against surface, 120, of outer race 36 of sprag clutch 60, which causes fingers 118 to flatten against surface 120 and become effective for rotating every sprag element 50 into locking contact with races 30 and 36, as is illustrated in FIG. 9B. When piston 82 is no longer activated, spring 106 returns piston 82 to a location such that ring 116 is no longer compressed and fingers 118 no longer rotate sprag elements 50.

### Example 3

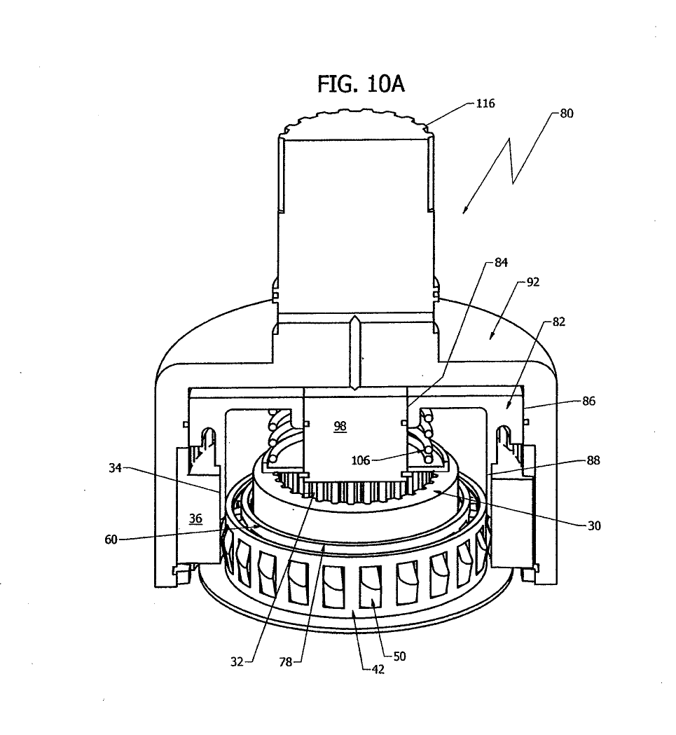

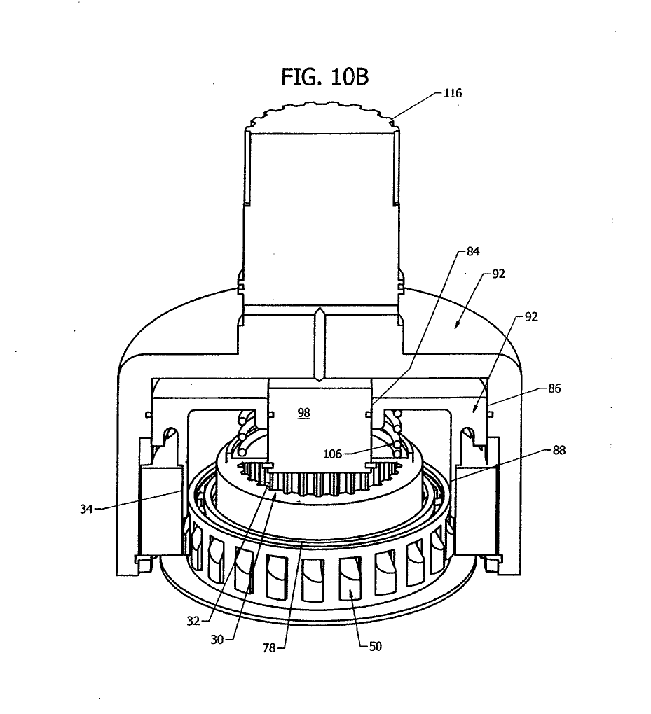

FIG. 10A is a schematic representation of a side perspective view of a cross section of input drum assembly, 80, similar to that described in FIG. 7, hereof, wherein cylindrical extension, 88, on piston 82 is adapted for sliding between inner surface 34 of outer race 36 of sprag clutch 60, and outer cage 42 of sprag cage assembly 78. When piston 82 is activated, extension 88 is moved into position for rotating every sprag element 50 into locking contact with inner and outer races 30 and 36, as is illustrated in FIG. 10B. When piston 82 is no longer activated, spring 106 returns piston 82 to a location such that extension 88 no longer rotates sprag elements 50, and they return to their floating condition.

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A sprag clutch capable of freewheeling in both directions and locking in one direction, comprising:
an inner race having a cylindrical outer surface and a first axis;
an outer race having a cylindrical inner surface and a second axis, said inner race and said outer race forming a first annular region therebetween, and wherein the first axis and the second axis are collinear;
a plurality of sprag elements, each of said sprag elements in said plurality of sprag elements having opposing longitudinal race contact faces, each of the opposing contact faces having a high region and a low region, there being an intersecting long diagonal dimension between opposing high regions of the opposing faces and a short diagonal dimension between opposing low regions of the opposing faces, respectively, a first end and an opposing second end, and a longitudinal sprag element axis of rotation passing through the intersection, and each of said sprag elements having portions removed beginning at opposite longitudinal ends of the race contact faces and extending inwardly to at least the midpoint of the contact face of said sprag element;
an inner cage having a plurality of slots therethrough into each of which a sprag element is capable of rotating, and a third axis;
an outer cage having a plurality of slots therethrough into each of which a sprag element is capable of rotating, and a fourth axis, wherein the third axis and the fourth axis are collinear, said inner cage and said outer cage forming a second annular region therebetween, wherein each sprag element in said plurality of sprag elements is disposed around the second annular region, said inner cage and said outer cage being capable of moving relative to each other along the third axis and the fourth axis; and
means for translating said first cage relative to said second cage along the collinear third axis and fourth axis;
whereby rotation of each of said sprag elements around a second sprag axis of rotation perpendicular to the first longitudinal sprag axis of rotation in addition to rotation about the first longitudinal sprag axis of rotation prevents engagement of the contact surfaces of each of said sprag elements with the inner surface of said outer race or the outer surface of said inner race for either direction of relative rotational motion of said inner race and said outer race, except when these elements are moved into contact with the inner surface of said outer race or the outer surface of said inner race by the translation of said first cage relative to said second cage.

2. The sprag clutch of claim 1, wherein each of said sprag elements readily disengage from the inner and outer races when said first cage and said second cage are no longer translated relative to each other.

3. A sprag clutch capable of freewheeling in both directions and locking in one direction, comprising:
an inner race having a cylindrical outer surface and a first axis;
an outer race having a cylindrical inner surface and a second axis, said inner race and said outer race forming a first annular region therebetween, and wherein the first axis and the second axis are collinear;
a plurality of sprag elements, each of said sprag elements in said plurality of sprag elements having opposing longitudinal race contact faces, each of the opposing contact faces having a high region and a low region, there being an intersecting long diagonal dimension between opposing high regions of the opposing faces and a short diagonal dimension between opposing low regions of the opposing faces, respectively, a first end and an opposing second end, and a longitudinal sprag element axis of rotation passing through the intersection, and each of said sprag elements having portions removed beginning at opposite longitudinal ends of the race contact faces and extending inwardly to the midpoint of the contact face of said sprag element;
an inner cage having a plurality of slots therethrough into each of which a sprag element is capable of rotating, and a third axis;
an outer cage having a plurality of slots therethrough into each of which a sprag element is capable of rotating, and a fourth axis, wherein the third axis and the fourth axis are collinear, said inner cage and said outer cage forming a second annular region therebetween, wherein each sprag element in said plurality of sprag elements is disposed around the second annular region, said inner cage and said outer cage being capable of moving relative to each other along the third axis and the fourth axis; and
means for translating said first cage relative to said second cage along the collinear third axis and fourth axis;
whereby rotation of each of said sprag elements around a second sprag axis of rotation perpendicular to the first longitudinal sprag axis of rotation in addition to rotation about the first longitudinal sprag axis of rotation prevents engagement of the contact surfaces of each of said sprag elements with the inner surface of said outer race or the outer surface of said inner race for either direction of relative rotational motion of said inner race and said outer race, except when these elements are moved into contact with the inner surface of said outer race or the outer surface of said inner race by the translation of said first cage relative to said second cage.

4. The sprag clutch of claim 3, wherein each of said sprag elements readily disengage from the inner and outer races when said first cage and said second cage are no longer translated relative to each other.

5. A sprag clutch element having opposing longitudinal race contact faces, each of the opposing contact faces having a high region and a low region, there being an intersecting long diagonal dimension between opposing high regions of the opposing faces and a short diagonal dimension between opposing low regions of the opposing faces, respectively, a first end and an opposing second end, and a longitudinal axis of rotation passing through the intersection, and having portions removed beginning at opposite longitudinal ends of the race contact faces and extending inwardly to at least the midpoint of the contact face of said sprag element.

6. A sprag clutch element having opposing longitudinal race contact faces, each of the opposing contact faces having a high region and a low region, there being an intersecting long diagonal dimension between opposing high regions of the opposing faces and a short diagonal dimension between opposing low regions of the opposing faces, respectively, a first end and an opposing second end, and a longitudinal axis of rotation passing through the intersection, and having portions removed beginning at opposite longitudinal ends of the race contact faces and extending inwardly to the midpoint of the contact face of said sprag element.
